(19) United States
(12) Patent Application Publication
(10) Pub. No.: US 2025/0219129 A1
(43) Pub. Date: Jul. 3, 2025

(54) SOLID-STATE ELECTROLYTE SYNTHESIS USING A SULFUR-CONTAINING ADDITIVE

(71) Applicant: Solid Power Operating, Inc., Louisville, CO (US)

(72) Inventors: Sean P. CULVER, Broomfield, CO (US); Bradley J. ROSS, Norman, OK (US); Jed LACOSTE, Denver, CO (US); Megan M. WEBSTER, Denver, CO (US)

(21) Appl. No.: 19/005,084

(22) Filed: Dec. 30, 2024

Related U.S. Application Data
(60) Provisional application No. 63/616,271, filed on Dec. 29, 2023.

(51) Int. Cl. H01M 10/056

(52) U.S. Cl. CPC H01M 10/056; H01M 2300/0065

(57) ABSTRACT

Described herein are processes for producing solid electrolyte materials. The processes include milling a slurry containing one or more solid electrolyte precursors, a solvent, and an additive, wherein the additive includes a compound comprising one or more sulfur atoms. Further provided herein are suspensions containing one or more solid electrolyte precursors, a solvent, and an additive, wherein the additive includes a compound comprising one or more sulfur atoms.

### CROSS-REFERENCE TO RELATED APPLICATION

This application is related to and claims priority under 35 U.S.C. § 119 (e) to U.S. Patent Application No. 63/616,271, filed Dec. 29, 2023, titled “Solid-State Electrolyte Synthesis Using a Sulfur-Containing Surfactant,” the entire contents of which is incorporated herein by reference for all purposes.

### FIELD OF THE DISCLOSURE

The present disclosure is related to processes for making solid electrolyte materials using additives that contain one or more sulfur atoms.

### BACKGROUND AND INTRODUCTION

Advancing battery technologies is paramount to meet the ever-increasing adoption of mobile devices, electric and hybrid vehicles, and other battery powered devices; therefore, the need for battery technologies with improved reliability, capacity (Ah), thermal characteristics, lifetime, and recharge performance has never been greater. Solid-state battery cells utilize a solid electrolyte less likely to develop shorts and fires as compared to liquid electrolyte used in traditional batteries. Thus, solid-state battery cells are typically safer for use in comparison to traditional batteries. However, there remain issues with currently available solid-state battery cells to ensure their wide adoption in the market. Among the issues is that solid-state battery cells can be costly to produce because some raw materials can be expensive, and the manufacturing process complicated.

It is with these observations in mind, among others, that aspects of the present disclosure were conceived. In brief summary, to overcome these challenges, among others, a novel process for synthesizing a solid electrolyte for use in solid-state battery cells has been developed, which is described herein.

### SUMMARY OF DISCLOSURE

Provided herein are processes for preparing solid electrolyte materials. The processes generally include milling a slurry comprising one or more solid electrolyte precursors, a solvent, and a surfactant, wherein the surfactant includes a compound comprising one or more sulfur atoms. In some embodiments, the milling is accomplished in a ball mill. In some embodiments, the milling is accomplished using milling media comprising zirconia or alumina.

In some embodiments, the additive includes two or more sulfur atoms. In some embodiments, the additive is present in the slurry in an amount of about 5 wt % or less, or about 2 wt % or less, or about 1 wt % or less, or about 0.5 wt % or less. In some embodiments, the solvent is present in the slurry in an amount from about 50% to about 90% by weight. In some embodiments, the additive comprises a C₁-C₁₅ hydrocarbon substituted with one or more C₁-C₁₀ alkyl-sulfide groups, one or more C₁-C₁₀ alkyl-disulfide groups, or a combination thereof. In some aspects, the C₁-C₁₅ hydrocarbon is linear. In some aspects, the C₁-C₁₅ hydrocarbon is branched. In some embodiments, the additive has a formula selected from:

R₁—S—R₂ (I);

R₁—S—S—R₂ (II);

R₁—S—R₂—S—R₃ (III); and

R₁(—S—R₂)ₙ (IV)
wherein each of R₁, R₂, and R₃ is independently a C₁-C₁₅ hydrocarbon, and n is an integer from 1-4.

In some embodiments, the additive is selected from the group consisting of propyl methyl sulfide, butyl methyl sulfide, pentyl methyl sulfide, hexyl methyl sulfide, heptyl methyl sulfide, octyl methyl sulfide, nonyl methyl sulfide, decyl methyl sulfide, undecyl methyl sulfide, dodecyl methyl sulfide, and a combination thereof. In some embodiments, the additive is selected from the group consisting of propyl methyl disulfide, butyl methyl disulfide, pentyl methyl disulfide, hexyl methyl disulfide, heptyl methyl disulfide, octyl methyl disulfide, nonyl methyl disulfide, decyl methyl disulfide, undecyl methyl disulfide, dodecyl methyl disulfide, and a combination thereof. In some embodiments, the additive includes tris(methylthio)methane.

In some embodiments, the solid electrolyte precursors include a lithium source, a compound comprising phosphorus and sulfur, a sulfur source, or any combination thereof. In some embodiments, the slurry has a viscosity from about 10 cP to about 1000 cP at a shear rate of 100 s⁻¹. In some embodiments, the solvent comprises an aprotic hydrocarbon, an ester, an ether, a nitrile, or any combination thereof. In some embodiments, the slurry has a solids content of about 10% to about 50% by weight.

Further provided herein are solid electrolyte materials prepared by the processes described herein.

Further provided herein is a suspension comprising one or more solid electrolyte precursors, a solvent, and an additive, wherein the additive includes one or more sulfur atoms. In some embodiments, the additive includes a compound comprising two or more sulfur atoms. In some embodiments, the additive comprises a C₁-C₁₅ hydrocarbon substituted with one or more C₁-C₁₀ alkyl-sulfide groups, one or more C₁-C₁₀ alkyl-disulfide groups, or a combination thereof. In some embodiments, the C₁-C₁₅ hydrocarbon is linear. In some embodiments, the C₁-C₁₅ hydrocarbon is branched. In some aspects, the C₁-C₁₅ hydrocarbon is branched. In some embodiments, the additive has a formula selected from:

R₁—S—R₂ (I);

R₁—S—S—R₂ (II);

R₁—S—R₂—S—R₃ (III); and

R₁(—S—R₂)ₙ (IV),
wherein each of R₁, R₂, and R₃ is independently a C₁-C₁₅ hydrocarbon, and n is an integer from 1-4.

In some embodiments, the additive is present in the suspension in an amount of about 5 wt % or less, or about 2 wt % or less, or about 1 wt % or less, or about 0.5 wt % or less. In some embodiments, the solvent is present in the suspension in an amount from about 50% to about 90% by weight. In some embodiments, the solid electrolyte precursors include a lithium source, a compound comprising phosphorus and sulfur, a sulfur source, or any combination thereof. In some embodiments, the suspension has a viscosity from about 10 cP to about 1000 cP at a shear rate of 100 s⁻¹.

### BRIEF DESCRIPTION OF THE FIGURES

FIG. 1 shows a process flow diagram of the processes of the present disclosure.

FIG. 2A shows the storage modulus (G′) and the loss modulus (G″) of slurries prepared using no additive (□), an aromatic hydrocarbon additive (▾), and a sulfide additive (∘).

FIG. 2B shows the viscosity of slurries prepared using no additive (□), an aromatic hydrocarbon additive (∘), a sulfide additive (▴), and an amine additive (▾).

FIG. 2C shows the viscosity and flow point of slurries prepared using no additive, an aromatic hydrocarbon additive, a sulfide additive, and an amine additive.

FIG. 3 shows the ionic conductivity of electrolyte materials synthesized using slurries prepared using no additive, an aromatic hydrocarbon additive, a sulfide additive, and an amine additive.

FIG. 4 shows X-ray diffraction patterns of electrolyte materials synthesized using slurries prepared using no additive, an aromatic hydrocarbon additive, a sulfide additive, and an amine additive.

FIG. 5A shows X-ray diffraction patterns of electrolyte materials synthesized using slurries prepared using no additive, an additive comprising a compound including one sulfur atom, an additive comprising a compound including two sulfur atoms, and an additive comprising a compound including three sulfur atoms.

FIG. 5B shows the ionic conductivity of electrolyte materials synthesized using slurries prepared using no additive, an additive comprising a compound including one sulfur atom, an additive comprising a compound including two sulfur atoms, and an additive comprising a compound including three sulfur atoms.

FIG. 6A shows the viscosity of slurries prepared using no additive, an additive comprising a compound including one sulfur atom, an additive comprising a compound including two sulfur atoms, and an additive comprising a compound including three sulfur atoms.

FIG. 6B shows an FT-IR spectra of electrolyte materials synthesized from slurries prepared using no additive, an additive comprising a compound including one sulfur atom, an additive comprising a compound including two sulfur atoms, and an additive comprising a compound including three sulfur atoms.

FIG. 7 shows an FT-IR spectra of electrolyte materials synthesized from slurries prepared using no additive, an additive comprising 0.5 wt % dodecyl methyl sulfide, an additive comprising 1.0 wt % of dodecyl methyl sulfide, pure dodecyl methyl sulfide, and an ester solvent.

### DETAILED DESCRIPTION

Before aspects of the present invention are disclosed and described, it is to be understood that this invention is not limited to the particular methods, compositions, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

Concentrations, amounts, and other numerical data may be expressed or presented herein in a range format. It is to be understood that such a range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 2 to about 50” should be interpreted to include not only the explicitly recited values of 2 to 50, but also include all individual values and sub-ranges within the indicated range. Thus, included in this numerical range are individual values such as 2, 2.4, 3, 3.7, 4, 5.5, 10, 10.1, 14, 15, 15.98, 20, 20.13, 23, 25.06, 30, 35.1, 38.0, 40, 44, 44.6, 45, 48, and sub-ranges such as from 1-3, from 2-4, from 5-10, from 5-20, from 5-25, from 5-30, from 5-35, from 5-40, from 5-50, from 2-10, from 2-20, from 2-30, from 2-40, from 2-50, etc. This same principle applies to ranges reciting only one numerical value as a minimum or a maximum. Furthermore, such an interpretation should apply regardless of the breadth of the range or the characteristics being described.

As used herein, the term “about” is used to provide flexibility to a numerical range endpoint by providing that a given value may be “a little above” or “a little below” the endpoint. For example, the endpoint may be within 10%, 8%, 5%, 3%, 2%, or 1% of the listed value. Further, for the sake of convenience and brevity, a numerical range of “about 50 mg/ml to about 80 mg/mL” should also be understood to provide support for the range of “50 mg/mL to 80 mg/mL.” The endpoint may also be based on the variability allowed by an appropriate regulatory body, such as the FDA, USP, etc.

In this disclosure, the terms “including,” “containing,” and/or “having” are understood to mean comprising, and are open ended terms.

Terms used herein may be preceded and/or followed by a single dash (“-” or “—”) or a double dash (“═”) to indicate the bond order of the bond between the named substituent and its parent moiety; a single dash indicates a single bond and a double dash indicates a double bond. In the absence of a single or double dash it is understood that a single bond is formed between the substituent and its parent moiety; further, substituents are intended to be read “left to right” unless a dash indicates otherwise. For example, C₁-C₆ alkoxycarbonyloxy and —OC(O)C₁-C₆ alkyl indicate the same functionality; similarly, arylalkyl and -alkylaryl indicate the same functionality.

The term “alkyl” as used herein, means a straight or branched chain hydrocarbon containing from 1 to 15 carbon atoms unless otherwise specified. Representative examples of alkyl groups include, but are not limited to, methyl, ethyl, n-propyl, iso-propyl, n-butyl, sec-butyl, iso-butyl, tert-butyl, n-pentyl, isopentyl, neopentyl, n-hexyl, 3-methylhexyl, 2,2-dimethylpentyl, 2,3-dimethylpentyl, n-heptyl, n-octyl, n-nonyl, and n-decyl. When an “alkyl” group is a linking group between two other moieties, then it may also be a straight or branched chain; examples include, but are not limited to —CH₂—, —CH₂CH₂—, —CH₂CH₂CHC(CH₃)—, and —CH₂CH(CH₂CH₃)CH₂—.

The term “alkynyl” as used herein, means a straight or branched chain hydrocarbon group containing from 2 to 10 carbon atoms and containing at least one carbon-carbon triple bond. Representative examples of alkynyl groups include, but are not limited, to acetylenyl, 1-propynyl, 2-propynyl, 3-butynyl, 2-pentynyl, and 1-butynyl.

The term “alkenyl” as used herein, means a straight or branched chain hydrocarbon containing from 2 to 10 carbons, unless otherwise specified, and containing at least one carbon-carbon double bond. Representative examples of alkenyl include, but are not limited to, ethenyl, 2-propenyl, 2-methyl-2-propenyl, 3-butenyl, 4-pentenyl, 5-hexenyl, 2-heptenyl, 2-methyl-1-heptenyl, and 3-decenyl.

Described herein are processes for preparing solid electrolyte materials. The processes include milling a slurry. The slurry comprises one or more solid electrolyte precursors, a solvent, and an additive. The additive includes a compound containing one or more sulfur atoms, referred to herein as a “sulfur additive.” The inventors surprisingly found that the use of the sulfur additive reduces the viscosity of the precursor slurry during the milling/grinding process and has a beneficial impact on the morphology and particle size of the final crystallized electrolyte material.

The sulfur additive may include one or more sulfur atoms, such as one sulfur atom, two sulfur atoms, three sulfur atoms, etc. The sulfur additive generally further includes hydrocarbons bound to the one or more sulfur atoms. In some embodiments, the sulfur additive comprises a C₁-C₁₅ hydrocarbon substituted with one or more C₁-C₁₀ alkyl-sulfide (—S—R) groups, one or more C₁-C₁₀ alkyl-disulfide (—S—S—R) groups, or a combination thereof. The C₁-C₁₅ hydrocarbon may be linear or branched, and may optionally be substituted. The C₁-C₁₅ hydrocarbon may be a C₁-C₁₅ alkyl, a C₂-C₁₅ alkenyl, or a C₂-C₁₅ alkynyl chain. As used herein, a C₁-C₁₀ alkyl-sulfide group is defined by the formula (—S—R), wherein R is a C₁-C₁₀ alkyl chain. The C₁-C₁₀ alkyl chain may be linear or branched, and may optionally be substituted. Similarly, a C₁-C₁₀ alkyl-disulfide group is defined by the formula (—S—S—R), wherein R is a C₁-C₁₀ alkyl chain. The C₁-C₁₀ alkyl chain may be linear or branched, and may optionally be substituted.

In some embodiments the sulfur additive may have the structure of formula (I):

R₁—S—R₂ (I),

wherein each of R₁ and R₂ is independently a C₁-C₁₅ hydrocarbon.

In some embodiments the sulfur additive may have the structure of formula (II):

R₁—S—S—R₂ (II),

wherein each of R₁ and R₂ is independently a C₁-C₁₅ hydrocarbon.

In some embodiments the sulfur additive may have the structure of formula (III):

R₁—S—R₂—S—R₃ (III),

wherein each of R₁, R₂, and R₃ is independently a C₁-C₁₅ hydrocarbon.

In some embodiments the sulfur additive may have the structure of formula (IV):

R₁(—S—R₂)ₙ (IV),

wherein R₁ is a C₁-C₁₅ hydrocarbon, R₂ is a C₁-C₁₀ alkyl chain as described above, and n is an integer from 1 to 4. For example, n may be 1, 2, 3, or 4. In some examples n may be 1.

The sulfur additive may comprise a sulfide, such as propyl methyl sulfide, butyl methyl sulfide, pentyl methyl sulfide, hexyl methyl sulfide, heptyl methyl sulfide, octyl methyl sulfide, nonyl methyl sulfide, decyl methyl sulfide, undecyl methyl sulfide, dodecyl methyl sulfide, or a combination thereof.

The sulfur additive may comprise a disulfide, such as propyl methyl disulfide, butyl methyl disulfide, pentyl methyl disulfide, hexyl methyl disulfide, heptyl methyl disulfide, octyl methyl disulfide, nonyl methyl disulfide, decyl methyl disulfide, undecyl methyl disulfide, dodecyl methyl disulfide, or a combination thereof.

In an example, the sulfur additive may include tris(methylthio)methane.

The sulfur additive may be present in the slurry in an amount of about 5% or less by weight of the slurry, such as about 4% or less by weight of the slurry, about 3% or less by weight of the slurry, about 2% or less by weight of the slurry, about 1% or less by weight of the slurry, or about 0.5% or less by weight of the slurry. For example, the sulfur additive may be present in the slurry in an amount of about 0% to about 0.5%, about 0% to about 1%, about 0% to about 2%, about 0% to about 3%, about 0% to about 4%, about 0% to about 5%, about 0.5% to about 5%, about 1% to about 5%, about 2% to about 5%, about 3% to about 5%, about 4% to about 5%, about 1% to about 3%, about 1% to about 2%, about 0.5% to about 2%, or about 0.5% to about 1% by weight of the slurry.

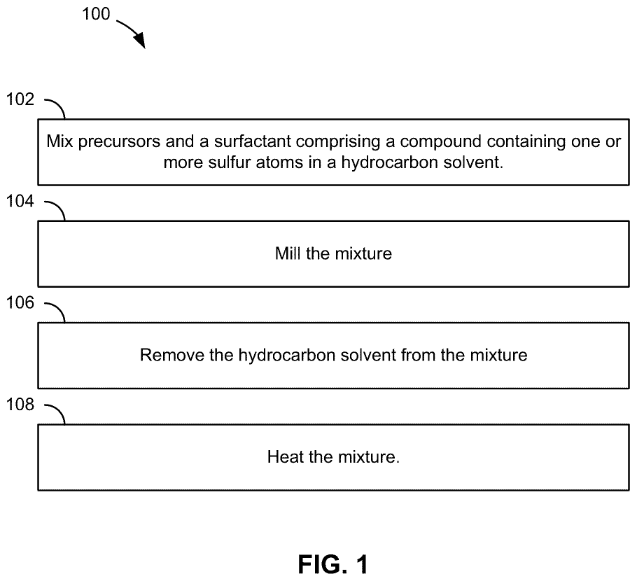

Turning now to FIG. 1, the process 100 of the present disclosure generally includes: a) mixing solid electrolyte precursors and an additive comprising a compound containing one or more sulfur atoms in a solvent at step 102; b) milling the mixture at step 104; c) removing the solvent from the mixture at step 106; and d) optionally heating the mixture to form the solid electrolyte material at step 108. The solid electrolyte precursors may include one or more lithium sources, a compound containing phosphorus and sulfur, a sulfur source, or any combination thereof.

The mixing in step 102 may be accomplished by methods generally known in the art. In some embodiments, agitators including agitated media mills, twin screw compounders, and other high shear equipment may be used to mix the precursors.

The solvent in the slurry may be selected from but is not limited to one of the following: aprotic hydrocarbons, esters, ethers or nitriles. In another aspect, the aprotic hydrocarbons may be selected from but are not limited to one of the following: xylenes, toluene, benzene, methyl benzene, hexanes, heptane, octane, alkanes, isoparaffinic hydrocarbons or a combination thereof. In another aspect, the esters may be selected from but are not limited to one of the following: butyl butyrate, isobutyl isobutyrate methyl propionate, ethyl propionate, propyl propionate, butyl propionate, methyl acetate, ethyl acetate, propyl acetate, butyl acetate or a combination thereof. In another aspect, the ethers may be selected from but are not limited to one of the following: diethyl ether, dibutyl ether, benzyl ether or a combination thereof. In another aspect, the nitriles may be selected from but are not limited to one of the following: acetonitrile, propionitrile, butyronitrile, pyrrolidine or a combination thereof.

The amount of solvent present in the slurry may be from about 50% to about 90% by weight of the slurry; in other words, the slurry may have a solids content from about 10% to about 50% by weight of the slurry. In some embodiments, the solvent may be present in the slurry in an amount from about 50% to about 60%, about 50% to about 70%, about 50% to about 80%, about 50% to about 90%, about 60% to about 90%, about 70% to about 90%, or about 80% to about 90% by weight of the slurry.

The milling in step 104 may comprise milling the mixture to a desired particle size. The milling preferably includes wet milling wherein the solvent used to form the mixture in step a) is present during the milling. The mixture may be milled for a predetermined period of time at a predetermined temperature to achieve a desired particle size. The milling may be accomplished using an attritor mill, an autogenous mill, a ball mill, a planetary ball mill, a buhrstone mill, a pebble mill, a rod mill, a semi-autogenous grinding mill, a tower mill, a vertical shaft impactor mill, or other milling apparatuses known in the art. Preferably, the milling is accomplished in a planetary ball mill or an attritor mill. The milling media may comprise zirconia, alumina, or other milling media known in the art.

Mixing time and milling time is not specifically limited as long as it allows for appropriate homogenization and reaction of the precursors to generate the solid electrolyte material. The mixing temperature is also not specifically limited as long as it allows for appropriate mixing and is not so high that a precursor enters the gaseous state. The mixing and milling may be accomplished in an inert atmosphere (e.g., a nitrogen, argon, or other inert atmosphere), a moisture-free atmosphere (i.e., less than 1% humidity), or an ambient atmosphere.

The slurry may have a viscosity from about 10 cP to about 1000 cP at a shear rate of 100 s⁻¹. In some embodiments, the slurry may have a viscosity from about 10 cP to about 50 cP, about 10 cP to about 100 cP, about 10 cP to about 200 cP, about 10 cP to about 300 cP, about 10 cP to about 400 cP, about 10 cP to about 500 cP, about 10 cP to about 600 cP, about 10 cP to about 700 cP, about 10 cP to about 800 cP, about 10 cP to about 900 cP, about 10 cP to about 1000 cP, about 50 cP to about 1000 cP, about 100 cP to about 1000 cP, about 200 cP to about 1000 cP, about 300 cP to about 1000 cP, about 400 cP to about 1000 cP, about 500 cP to about 1000 cP, about 600 cP to about 1000 cP, about 700 cP to about 1000 cP, about 800 cP to about 1000 cP, or about 900 cP to about 1000 cP.

The solvent is removed from the mixture in step 106. The solvent may be removed by various separation methods known in the art, such as evaporation and filtration. In particular embodiments, the solvent may be removed via evaporation, gravity filtration, vacuum filtration, centrifugation, desiccation, and other methods known in the art.

When removing the solvent via evaporation, the milled mixture may be heated to a temperature from about 20° C. to about 250° C. Those having skill in the art will appreciate that the optimal temperature for evaporation will depend on the solvent used; e.g., high-molecular weight hydrocarbons will generally require higher temperatures to evaporate. The milled mixture may be heated to a temperature from about 20° C. to about 50° C., about 20° C. to about 100° C., about 20° C. to about 150° C., about 20° C. to about 200° C., about 20° C. to about 250° C., about 50° C. to about 250° C., about 100° C. to about 250° C., about 150° C. to about 250° C., or about 200° C. to about 250° C.

The amount of solvent removed may vary. In some embodiments, all or substantially all of the solvent may be removed from the milled mixture. In other embodiments, about 95%, about 90%, about 85%, about 80%, about 75%, or less than about 75% of the solvent may be removed. In still other embodiments, about 99% to about 75% of the solvent may be removed, such as from about 99% to about 95%, about 99% to about 90%, about 99% to about 85%, about 99% to about 80%, about 99% to about 75%, about 95% to about 75%, about 90% to about 75%, about 85% to about 75%, or from about 80% to about 75% of the solvent may be removed.

When the process 100 includes heating step 108, the precursors in the milled mixture may be heated to a temperature between about 150° C. and about 600° C. The precursors may be heated to a temperature from about 150° C. to about 200° C., about 150° C. to about 250° C., about 150° C. to about 300° C., about 150° C. to about 350° C., about 150° C. to about 400° C., about 150° C. to about 450° C., about 150° C. to about 500° C., about 150° C. to about 550° C., about 150° C. to about 600° C., about 200° C. to about 600° C., about 250° C. to about 600° C., about 300° C. to about 600° C., about 350° C. to about 600° C., about 400° C. to about 600° C., about 450° C. to about 600° C., about 500° C. to about 600° C., about 550° C. to about 600° C., about 200° C. to about 400° C., about 200° C. to about 350° C., or about 250° C. to about 350° C. As an example, the precursors may be heated in step b) to a temperature of about 150° C., about 175° C., about 200° C., about 225° C., about 250° C., about 275° C., about 300° C., about 325° C., about 350° C., about 375° C., about 400° C., about 425° C., about 450° C., about 475° C., about 500° C., about 525° C., about 550° C., about 575° C., or about 600° C. Those having skill in the art will appreciate that the temperature may be limited or adjusted based on factors such as the type of equipment used or the atmospheric pressure.

The heating may occur for a period of time from about 5 seconds to about 5 hours. For example, the heating may occur for a period from about 5 second to about 10 seconds, about 5 seconds to about 30 seconds, about 5 seconds to about 1 minute, about 5 seconds to about 10 minutes, about 5 seconds to about 30 minutes, about 5 seconds to about 1 hour, about 5 seconds to about 3 hours, about 5 seconds to about 5 hours, about 10 seconds to about 5 hours, about 30 seconds to about 5 hours, about 1 minute to about 5 hours, about 10 minutes to about 5 hours, about 30 minutes to about 5 hours, about 1 hour to about 5 hours, or about 3 hours to about 5 hours.

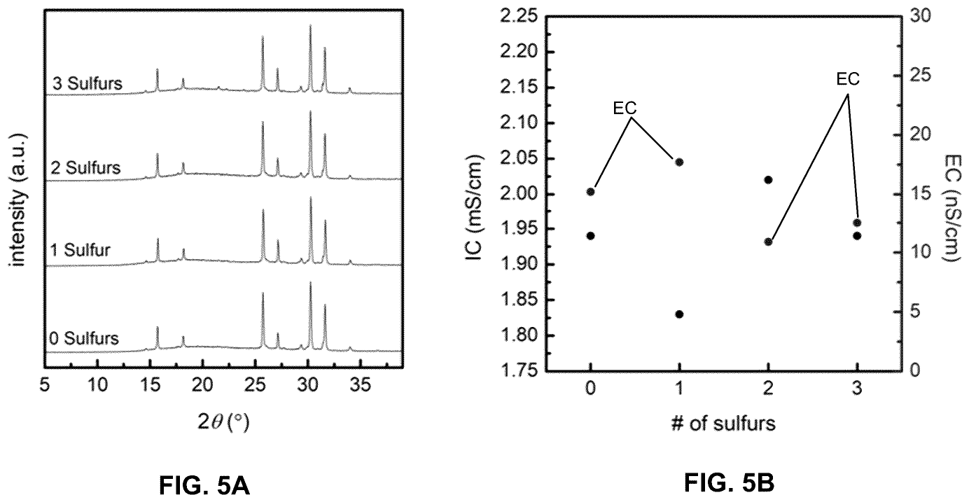

In some embodiments, an amount of the sulfur additive may remain on the surface of the solid electrolyte material particles after the heat treatment. Stated another way, the sulfur additive may be “baked” onto the surface of the solid electrolyte material particles. This residual sulfur additive may be detectable using FT-IR spectroscopy, as shown in FIG. 5. In some aspects, the amount of sulfur additive remaining on the surface of the solid electrolyte material particles may be less than 1%, less than 0.1%, or less than 0.01% by weight of the solid electrolyte material.

Exemplary lithium sources may include one or more of Li₂S, Li₂CO₃, a lithium halide, a lithium pseudohalide, Li₂O, Li₃PO₄, LiBO₂, Li₂B₄O₇, Li₂ZrO₃, LiAlO₂, Li₂TiO₃, LiNbO₃, and Li₂SiO₃, or a mixture thereof. Exemplary lithium halides may include one or more of LiF, LiCl, LiBr, and LiI, while exemplary lithium pseudohalides may include LiNO₃, LiOH, Li₂SO₃, Li₃N, Li₂NH, LiNH₂, LiBF₄, LiBH₄, or a mixture thereof.

Exemplary compounds containing phosphorus and sulfur may include, for example, P₄S_{X} (where x ranges from 3 to 10) and P₂S₅. In an embodiment, phosphorus sulfide (P₄Sₓ) comprises mixtures of P₄Sₓ, where x ranges from 3 to 10, and may be a combination of P₄S₃, P₄S₄, P₄S₅, P₄S₆, P₄S₇, P₄S₈, P₄S₉, P₄S₁₀, and P₄Sₓ where x is a non-integer. The compounds containing phosphorus and sulfur may have a low melting temperature. As used herein, a low melting temperature is defined as a melting temperature of less than 300° C., such as 250° C. or less, 200° C. or less, or 150° C. or less.

P₄Sₓ may also be used as the compound containing phosphorus and sulfur, where x>10. In some embodiments, x may be greater than 40, or 10<x≤40. In other embodiments, P₄Sₓ is used as a precursor material to form solid electrolyte materials, where 10<x≤35, 10<x≤30, 10<x≤25, 10<x≤20, 10<x≤15, 10<x≤14, 10<x≤13, 10<x≤12, or 10<x≤11. In preferred embodiments, 10<x≤14. Without wishing to be bound by theory, when 10<x≤14, the P₄Sₓ is a crystalline-phase material with properties more preferred for forming solid electrolyte materials. When x is greater than about 14, the P₄Sₓ is an amorphous phase material due to the large relative quantities of sulfur.

When the precursors further include a compound containing phosphorus and sulfur, the P₄Sₓ, where x>10, may provide greater than 0% of the phosphorus used in the solid electrolyte material synthesis. For example, the P₄Sₓ, where x>10, may provide greater than 0%, greater than 5%, greater than 10%, greater than 20%, greater than 30%, greater than 40%, greater than 50%, greater than 60%, greater than 70%, greater than 80%, greater than 90%, or greater than 95% of the phosphorus used in the solid electrolyte material synthesis.

When the precursors further include a compound containing phosphorus and sulfur, the compound containing phosphorus and sulfur may provide greater than 0% of the phosphorus used in the solid electrolyte material synthesis. For example, the compound containing phosphorus and sulfur may provide greater than 0%, greater than 5%, greater than 10%, greater than 20%, greater than 30%, greater than 40%, greater than 50%, greater than 60%, greater than 70%, greater than 80%, greater than 90%, or greater than 95% of the phosphorus used in the solid electrolyte material synthesis.

In some embodiments, the methods may further include mixing a sulfur source with the one or more lithium sources and the P₄Sₓ. Exemplary sulfur sources may include, for example, elemental sulfur, sulfur vapor, a polysulfide, or H₂S gas. Non-limiting examples of polysulfides that may be used as the sulfur source include lithium polysulfide, sodium polysulfide, and potassium polysulfide. In an embodiment, the sulfur source is lithium polysulfide, such as Li₂Sₓ, where x is between 2 and 10. In embodiments where the sulfur source includes sulfur vapor or H₂S gas, the sulfur vapor or H₂S gas may be bubbled through or over the composite as heat is applied and the reaction is taking place. Alternatively, in embodiments where the sulfur source includes elemental sulfur, the elemental sulfur may be added directly to the composite mixture.

The elemental sulfur used herein may be solid sulfur or sulfur vapor (i.e., elemental sulfur heated above its sublimation or boiling point). When the elemental sulfur includes sulfur vapor, the sulfur vapor may be bubbled through the solvent during mixing and/or during milling. Solid elemental sulfur may be added to the mixture or to the solvent as a dry powder. Additionally, the elemental sulfur may be added to the mixture as a solution dissolved in a small portion of the solvent.

The molar ratio of phosphorus to lithium to sulfur (P:Li:S) may be selected such that the reaction produces a desired solid electrolyte material. The molar amount of phosphorus in the molar ratio may be selected from 1 about to about 4, such as from about 1 to about 2, from about 1 to about 3, from about 2 to about 3, from about 2 to about 4, or from about 3 to about 4. In some examples, the molar amount of phosphorus in the molar ratio may be 1, 1.5, 2, 2.5, 3, 3.5, or 4. The molar amount of lithium in the molar ratio may be selected from about 1 to about 9, such as from about 1 to about 3, from about 1 to about 5, from about 1 to about 7, from about 3 to about 5, from about 3 to about 7, from about 3 to about 9, from about 5 to about 7, from about 5 to about 9, or from about 7 to about 9. In some examples, the molar amount of lithium in the molar ratio may be 1, 1.5, 2, 2.5, 3, 3.5, 4, 4.5, 5, 5.5, 6, 6.5, 7, 7.5, 8, 8.5, or 9. The molar amount of sulfur in the molar ratio may be selected from about 3 to about 12, such as from about 3 to about 6, from about 3 to about 9, from about 3 to about 12, from about 6 to about 9, from about 6 to about 12, or from about 9 to about 12. In some examples, the molar amount of sulfur in the molar ratio may be 3, 3.5, 4, 4.5, 5, 5.5, 6, 6.5, 7, 7.5, 8, 8.5, 9, 9.5, 10, 10.5, 11, 11.5, 12, 12.5, or 13. Thus, the molar ratio of phosphorus to lithium to sulfur may be 1-4:1-9:3-12.

### EXAMPLES

### Example 1: Production of Solid Electrolyte Slurry—Baseline

Li₂S, P₄S₁₀, and LiCl were mixed together in a molar ratio to produce an Li₆₋ₓPS₅₋xClₓ material where 1≤x≤1.8. These materials were mixed with xylenes and a reactive solvent that is classified as an ester to form a slurry. No additive was added to this slurry.

### Example 2: Aromatic Hydrocarbon Additive

A slurry was prepared in accordance with Example 1, with the exception that about 1% by weight of phenyldodecane additive was added to the slurry.

### Example 3: Sulfide Additive

A slurry was prepared in accordance with Example 1, with the exception that about 1% by weight of dodecyl methyl sulfide (DDMS) additive was added to the slurry.

### Example 4: Amine Hydrocarbon Additive

A slurry was prepared in accordance with Example 1, with the exception that about 1% by weight of N,N-dimethyldodecylamine additive was added to the slurry. It was observed that the amine additive destabilized the slurry, causing separation of the solids from the solvents.

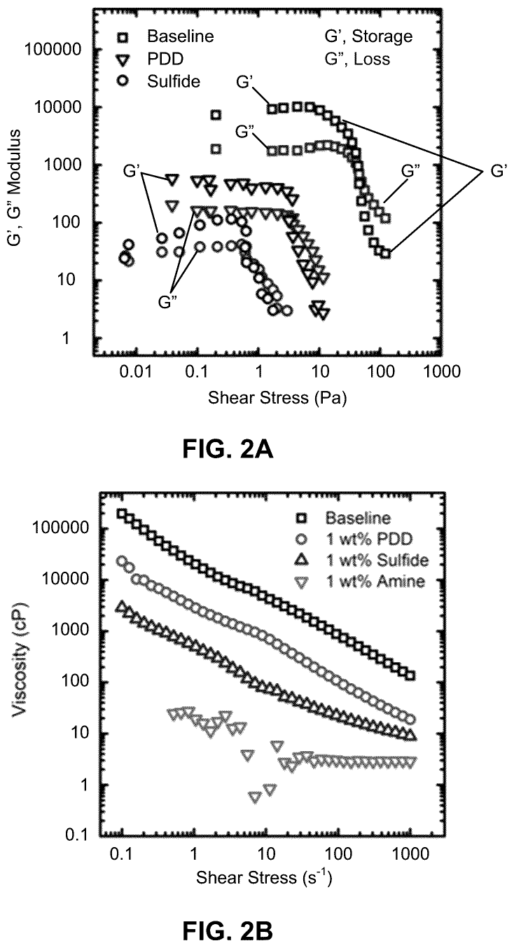

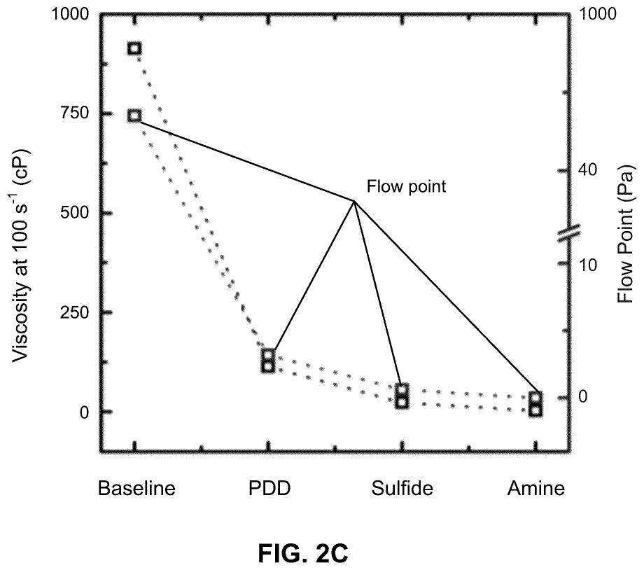

The viscosity, storage modulus (G′), loss modulus (G″), and flow point of the slurries prepared in Examples 1-4 were tested using a rheometer. The results are shown in FIGS. 2A-2C. Both the viscosity and flow point decreased with the use of an additive compared to baseline. The sulfide additive had lower viscosity compared to the aromatic hydrocarbon additive, but greater viscosity compared to the amine additive.

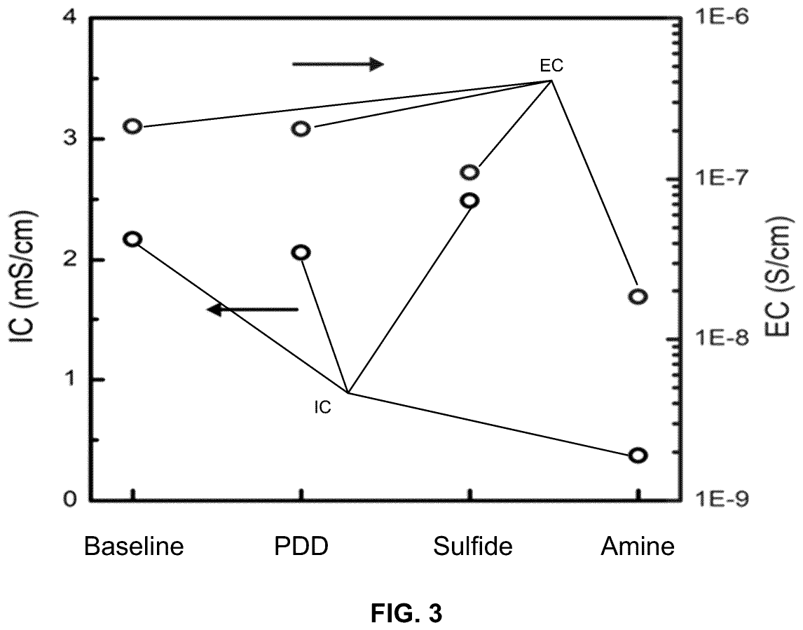

The ionic conductivity of the electrolytes prepared in Examples 1-4 was tested. The results are shown in FIG. 3. While the aromatic hydrocarbon additive and the sulfide additive improved the rheology of the slurry, they appeared to have little effect on the ionic conductivity of the electrolytes. In contrast, use of the amine additive significantly reduced the ionic conductivity of the electrolyte.

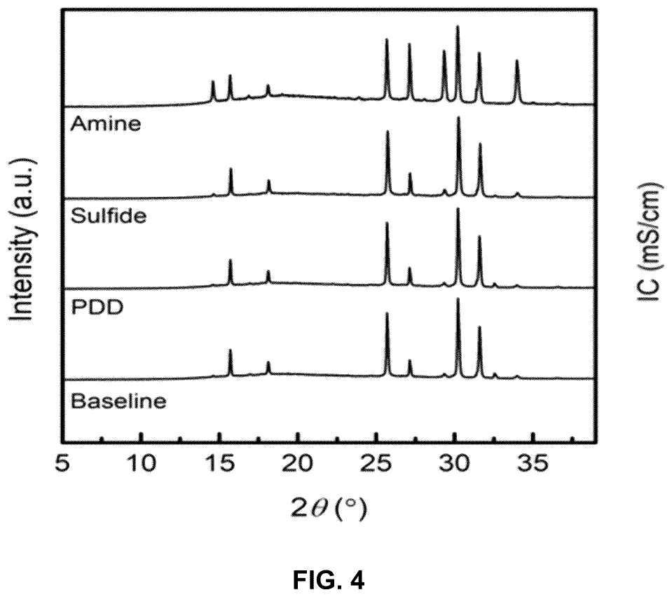

The x-ray diffraction patterns of the electrolytes prepared in Examples 1-4 was measured, shown in FIG. 4. As can be seen, several impurities appeared in the electrolytes prepared using the amine additive, likely contributing to the loss of ionic conductivity shown in FIG. 3.

### Example 5: Sulfide Additive

A slurry was prepared in accordance with Example 1, with the exception that about 1% by weight of propyl methyl sulfide additive was added to the slurry.

### Example 6: Disulfide Additive

A slurry was prepared in accordance with Example 1, with the exception that about 1% by weight of propyl methyl disulfide additive was added to the slurry.

### Example 7: Tris(Sulfide) Additive

A slurry was prepared in accordance with Example 1, with the exception that about 1% by weight of tris(methylthio) sulfide additive was added to the slurry.

The slurries and electrolytes prepared in Examples 5-7 were compared with the slurries and electrolytes prepared in Example 1. The properties are provided in Table 1 below.

TABLE 1

| | | | Molar | | | | | | | Viscosity |
|---|---|---|---|---|---|---|---|---|---|---|
| | BP | MW | Ratio | IC | EC | Density | d₁₀ | d₅₀ | d₉₀ | (cP @ |
| Example | (° C.) | (g/mol) | S:P₄S₁₀ | (mS/cm) | (nS/cm) | (g/cm³) | (μm) | (μm) | (μm) | 100 s⁻¹) |
| 1 | n/a | n/a | n/a | 1.94 | 15.2 | 1.458 | 0.606 | 3.70 | 10.2 | 205.7 |
| 5 | 97 | 90.18 | 0.39:1 | 1.83 | 17.7 | 1.421 | 0.439 | 2.95 | 9.75 | 227.13 |
| 6 | 70 | 122.3 | 0.58:1 | 2.02 | 10.9 | 1.450 | 0.701 | 4.16 | 10.4 | 141.5 |
| 7 | 102 | 154.32 | 0.69:1 | 1.94 | 12.5 | 1.453 | 0.438 | 1.80 | 10.4 | 36.21 |

X-ray diffraction patterns of the electrolytes made in each example were obtained, shown in FIG. 5A. “0 Sulfurs” refers to the electrolytes prepared in Example 1, “1 sulfur” refers to the electrolyte prepared in Example 5, “2 sulfurs” refers to the electrolyte prepared in Example 6, and “3 sulfurs” refers to the electrolyte prepared in Example 7. The ionic conductivity of the electrolytes made in each example was tested, shown in FIG. 5B.

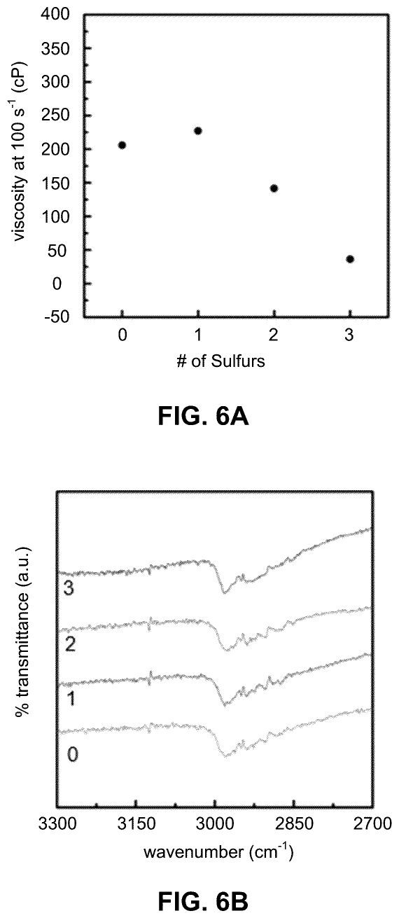

The viscosity of the slurries was tested, shown in FIG. 6A. The electrolytes made in each example were evaluated via FT-IR spectroscopy, shown in FIG. 6B.

### Example 8: Increasing Concentration of Sulfide Additive

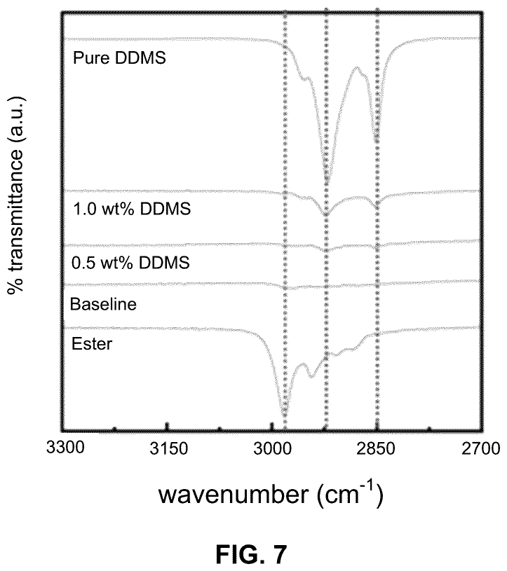

Electrolytes made from slurries prepared using no additive, an additive comprising 0.5 wt % dodecyl methyl sulfide, an additive comprising 1.0 wt % of dodecyl methyl sulfide, pure dodecyl methyl sulfide, and an ester solvent. were evaluated via FT-IR spectroscopy, shown in FIG. 7. The slurries were prepared in accordance with Example 1.

What is claimed is:

1. A process for preparing a solid electrolyte material, the method comprising milling a slurry comprising one or more solid electrolyte precursors, a solvent, and an additive, wherein the additive includes a compound comprising one or more sulfur atoms.

2. The process of claim 1, wherein the additive includes two or more sulfur atoms.

3. The process of claim 1, wherein the additive comprises a C₁-C₁₅ hydrocarbon substituted with one or more C₁-C₁₀ alkyl-sulfide groups, one or more C₁-C₁₀ alkyl-disulfide groups, or a combination thereof.

4. The process of claim 3, wherein the C₁-C₁₅ hydrocarbon is linear.

5. The process of claim 3, wherein the C₁-C₁₅ hydrocarbon is branched.

6. The process of claim 1, wherein the additive has a formula selected from the group consisting of:
R₁—S—R₂ (I);
R₁—S—S—R₂ (II);
R₁—S—R₂—S—R₃ (III); and
R₁(—S—R₂)ₙ (IV),
wherein each of R₁, R₂, and R₃ is independently a C₁-C₁₅ hydrocarbon, and n is an integer from 1-4.

7. The process of claim 1, wherein the additive is present in the slurry in an amount of about 5 wt % or less, or about 2 wt % or less, or about 1 wt % or less, or about 0.5 wt % or less.

8. The process of claim 1, wherein the solvent is present in the slurry in an amount from about 50% to about 90% by weight.

9. The process of claim 1, wherein the solid electrolyte precursors include a lithium source, a compound comprising phosphorus and sulfur, a sulfur source, or any combination thereof.

10. The process of claim 1, wherein the slurry has a viscosity from about 10 cP to about 1000 cP at a shear rate of 100 s⁻¹.

11. The process of claim 1, wherein the solvent comprises an aprotic hydrocarbon, an ester, an ether, a nitrile, or any combination thereof.

12. The process of claim 1, wherein the milling is accomplished in a ball mill.

13. The process of claim 1, wherein the slurry has a solids content of about 10% to about 50% by weight.

14. The process of claim 1, wherein the milling is accomplished using milling media comprising zirconia or alumina.

15. The process of claim 1, wherein the additive is selected from the group consisting of propyl methyl sulfide, butyl methyl sulfide, pentyl methyl sulfide, hexyl methyl sulfide, heptyl methyl sulfide, octyl methyl sulfide, nonyl methyl sulfide, decyl methyl sulfide, undecyl methyl sulfide, dodecyl methyl sulfide, and a combination thereof.

16. The process of claim 1, wherein the additive is selected from the group consisting of propyl methyl disulfide, butyl methyl disulfide, pentyl methyl disulfide, hexyl methyl disulfide, heptyl methyl disulfide, octyl methyl disulfide, nonyl methyl disulfide, decyl methyl disulfide, undecyl methyl disulfide, dodecyl methyl disulfide, and a combination thereof.

17. The process of claim 1, wherein the additive includes tris(methylthio)methane.

18. A solid electrolyte material obtained by the process of claim 1.

19. A suspension comprising one or more solid electrolyte precursors, a solvent, and an additive, wherein the additive includes one or more sulfur atoms.

20. The suspension of claim 19, wherein the additive includes a compound comprising two or more sulfur atoms.

21. The suspension of claim 19, wherein the additive comprises a C₁-C₁₅ hydrocarbon substituted with one or more C₁-C₁₀ alkyl-sulfide groups, one or more C₁-C₁₀ alkyl-disulfide groups, or a combination thereof.

22. The suspension of claim 21, wherein the C₁-C₁₅ hydrocarbon is linear.

23. The suspension of claim 21, wherein the C₁-C₁₅ hydrocarbon is branched.

24. The suspension of claim 19, wherein the additive has a formula selected from the group consisting of:
R₁—S—R₂ (I);
R₁—S—S—R₂ (II);
R₁—S—R₂—S—R₃ (III); and
R₁(—S—R₂)ₙ (IV),
wherein each of R₁, R₂, and R₃ is independently a C₁-C₁₅ alkyl, and n is an integer from 1-4.

25. The suspension of claim 19, wherein the additive is present in the suspension in an amount of about 5 wt % or less, or about 2 wt % or less, or about 1 wt % or less, or about 0.5 wt % or less.

26. The suspension of claim 19, wherein the solvent is present in the suspension in an amount from about 50% to about 90% by weight.

27. The suspension of claim 19, wherein the solid electrolyte precursors include a lithium source, a compound comprising phosphorus and sulfur, a sulfur source, or any combination thereof.

28. The suspension of claim 19, wherein the suspension has a viscosity from about 10 cP to about 1000 cP at a shear rate of 100 s⁻¹.
